(19) United States
(12) Patent Application Publication
(10) Pub. No.: US 2004/0066552 A1
(43) Pub. Date: Apr. 8, 2004

(54) Low profile stage

(76) Inventor: James A. Werba, Stockholm, NJ (US)

Correspondence Address: Richard Polidi, 12 Quail Hunt Circle, Durham, NC, 27712, US

(21) Appl. No.: 10/464,803

(22) Filed: Jun. 18, 2003

Related U.S. Application Data
(60) Provisional application No. 60/389,738, filed on Jun. 18, 2002.

(51) Int. Cl. G02B 21/26

(52) U.S. Cl. 359/391

(57) ABSTRACT

A low profile stage having a specially configured channel for positioning a screw therein.

### FIELD OF THE INVENTION

The present invention relates to an improved low profile stage for permitting a user to control the displacement of a carriage along a path of travel.

### BACKGROUND AND SUMMARY OF THE INVENTION

A variety of actuators and stages are known in the art. One type of actuator is a “linear actuator” which commonly includes a screw (ball screw or acme lead screw) and a nut which the screw operatively engages. Turning of the screw, e.g., by a reversible electric motor (such as a DC motor, stepper motor, servomotor, gearmotor etc.) causes the nut to travel therealong. The nut is typically mechanically fastened to a raveling member, i.e., carriage, which travels therewith along the length of the screw.

The carriage is often used for carrying and positioning a load along the length of the screw. Such load typically creates forces both longitudinal and axial with respect to the screw. The axial forces, because they are perpendicular to the screw, may cause the screw to bend. If bent, the screw runs less efficiently and may be inoperable.

It is known in the art to include one or more (commonly two parallel) “tracks,” e.g., rails, shafts, etc., in a linear stage. The carriage is displaceably connected to the tracks and travels along the tracks upon displacement by the screw. The tracks preferably carry a significant (if not total) portion of the load, in turn greatly reducing (if not eliminating) the axial “bending” forces exerted onto the screw. However, if the tracks are not sufficiently strong, they themselves may bend, reducing their effectiveness and possibly preventing motion of the cage—thus rendering the actuator inoperable. Even a small bend in the tracks may cause a greater portion of the axial forces to be exerted onto the screw, in turn bending and damaging the screw as well.

Accordingly, it is desirable to design a stage having tracks which are very strong and thus unlikely to bend even upon the application of a heavy load, e.g., torsional, axial, or longitudinal load.

It is also desirable to design a stage, the tracks of which are rigidly maintained parallel to each other, even upon the application of a heavy load.

It is also desirable to design an actuator which is economically and efficiently assembled, e.g., the tracks and other components of which are easily and quickly assembled to be in-line with each other.

It is also desirable to design an actuator which is easily maintained regardless of environment, e.g., dirty, damp, etc.

In many applications, it is desirable for an actuator to be “low-profile,” i.e., short. One such application is the use of multiple actuators in a multi-axis system. Because multiple actuators are “stacked” on top of each other, even a minor variance in height of one of the actuators is magnified for the overall assembly, when a lower height is instead desired.

Thus it would be very desirable to design the actuator to be low-profile, importantly while reducing its strength (and that of its tracks) by as little as possible (if at all) in order to permit the actuator to carry heavy loads.

The present invention is directed to a low-profile stage which includes the foregoing, and additional, desirable attributes. Rails are advantageously secured flat onto a single, solid, and rigid plate, thus imparting superior rigidity to the rails. The plate is preferably, although not necessarily metallic (it may instead be comprised, e.g., of a very hard plastic). The stage may be used in connection with virtually any of the many types of motors, controllers, drivers, limit switches, and associated circuitry known, as well as known associated hardware (e.g., control boxes, foot switches, hand switches, etc.). The motors may be high-speed, low-speed, variable- or constant-speed, etc. The stage may be mounted to a surface or the like by any of the many fastening methods known in the art, such as screwing, bolting, etc. A specially configured center channel permits free and unencumbered travel of the nut therein, as well as permitting the screw to be positioned lower with respect to the plate. These and other features of the present invention are disclosed in greater detail in the detailed invention (infra).

### BRIEF DESCRIPTIONS OF THE DRAWINGS

FIG. 1 is a perspective view of the stage of the present invention;

FIG. 2 is a sectional view of the stage of FIG. 1 taken along the line 2-2 in FIG. 1; and

FIG. 3 is a sectional view of the stage of FIG. 1 taken along the line 3-3 in FIG. 1.

### DETAILED DESCRIPTION OF THE PRESENT INVENTION

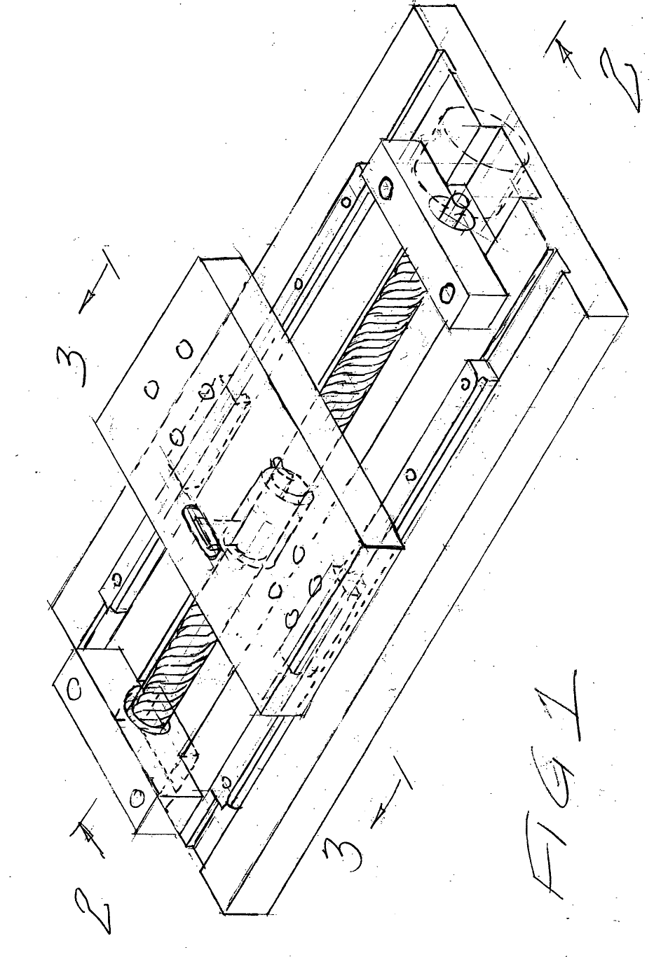

As shown in FIGS. 1-3, the stage of the present invention, referred to generally by reference numeral 10, includes a main plate 20 having a center channel 30 and preferably two offset channels 40, one on either side of the center channel 30, wherein the center and offset channels run longitudinally along the plate 40. The main plate preferably has several holes 50 for mounting the stage to a surface. In addition, it is contemplated that the main plate may have feet or similar structures for mounting purposes, as is commonly known in the art.

The channels 30, 40 may have rectangular cross-sections, curved cross-sections, triangular cross-sections, and/or additional configurations. Furthermore, some may be shaped one way and others a different way. A screw 60 (e.g., lead screw, acme lead screw, etc.) is positioned proximate (and preferably at least partly within) the center channel 30. A specially configured T-shaped bearing block 70 is positioned at either end of the screw for holding the screw securely upon the main plate. The bearing blocks 70 are configured, i.e. sized and shaped, for holding the screw securely in place and parallel to the center channel. The bearing blocks are typically, although not necessarily, fastened to the main plate 20 with screws 75 (bidden). It is also contemplated that the end bearing block have a lip for aligning it and securing it against an edge of the main plate.

The offset channels 40 are preferably shallower than the center channel and are configured for tightly securing tracks, i.e., rails 80, therein. Because the offset channels are relatively shallow, the thickness of the main plate directly below them is reduced only marginally. Each rail 80 is preferably laid flat (horizontally) upon the main plate 20 within a respective offset channel. Each rail 80 may be fastened to the main plate in any of many known ways, such as with screws. The offset channels advantageously permit very little, if any, “play” of the rails, thus effectively maintaining the parallelism of the rails 80 with respect to each other.

It is contemplated that the center channel 30 need not be positioned “centrally” in the main plate. Instead, such channel 30, as well as the screw positioned therein, may be offset. Similarly, the shallower channels 40 for securing the rails, and the rails 80 themselves, may be positioned differently with respect to the plate. For example, two shallow channels 40 may be positioned on one side of the plate while the deeper channel 30 is positioned on the other, while all three channels 30, 40 are also positioned parallel to each other.

A carriage 100 is specially configured for traveling along the rails 80. The carriage 100 includes a traveling plate 110 and preferably two guide blocks 120, one for each respective rail 80 (although it is also known to use multiple guide blocks for each rail in certain applications). Each guide block 120 may be fastened to the traveling plate 110 in any of many known ways, such as with screws. An a 130 in the traveling plate is positioned for receiving a flanged region 140 of a nut 150. The nut 150 may be fastened to the traveling plate in any of many known ways, such as with screws. The nut/screw assembly is preferably of the anti-backlash type in order to provide additional precision and consistency in use. The nut is, of course, configured for receiving the screw, whether of a re-circulating ball-bearing type for a ball screw, or of a standard type for an acme lead screw. The nut shown in FIGS. 1-3 includes a main body and “leaves” extending therefrom. The nut may also be supplied with a brush for cleaning and lubricating the screw as it travels. The nut advantageously travels along the screw without encumbrance in the center channel. It is further contemplated that other actuating mechanisms. may be used in connection with the stage of the present invention, such as belt drives, pneumatic drives, and hydraulic drives. In addition, the present stage may be used in connection with a pre-assembled (and housed) electromechanical linear actuator, such as the type available for purchase from McMaster-Carr, wherein such actuator directly engages the traveling plate.

It is contemplated that the various dimensions of the stage, screw, traveling plate, etc., may be varied for use in many applications. For example, the stroke length may be varied by selecting a screw and main plate of desired length. Preferably, the length of the main plate varies from 3 inches to 3 feet to vary the stroke length accordingly. However, dimensions outside this range are also contemplated and may be desirable for certain applications.

The rails may comprise any of a variety of types, shapes, and configurations known in the art. The same is the case with the guide blocks (e.g., profiled linear bearings). It is contemplated that the rails may also be mounted vertically to the main plate, either on their sides upon the top of the plate or flat against the sides of the plate (or even flat along a sidewall, if such sidewall is incorporated into the structure). In addition, it is contemplated that the rails may be mounted vertically along respective side edges of the main plate. It is preferable that the rails be mounted horizontally and flat on the main plate in order to maintain the rigidity and stability of the actuator when it is under axial, torsional, and longitudinal loads. It is also contemplated that shafts and linear bearings (open or closed types) may be used. It is also contemplated that the tracks/rails/linear beards may be mounted to main plate by means of mounting blocks or upon walls, as is known in the at.

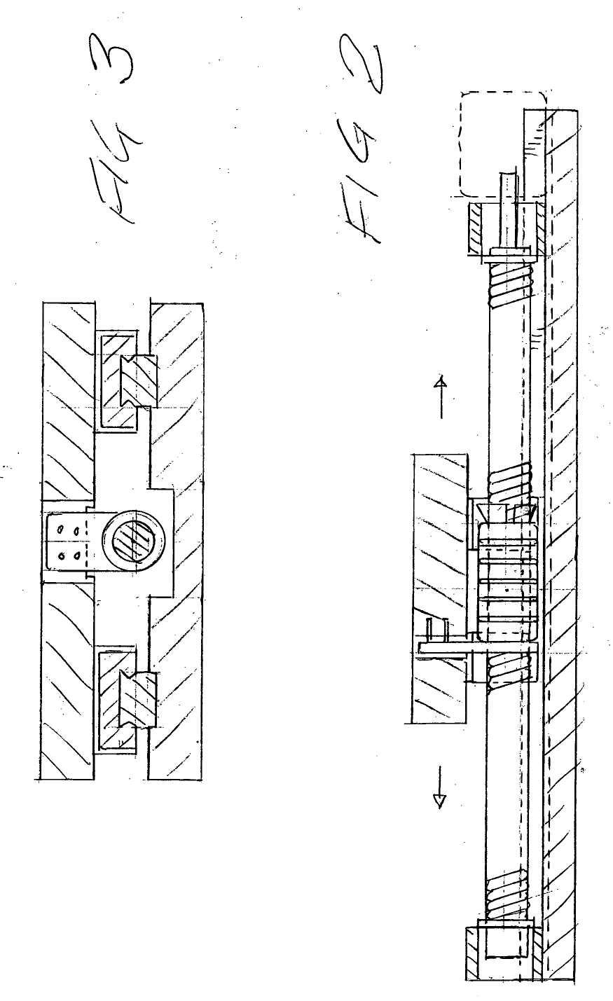

The screw has a “reduced” end 300 extending out of one of the mounting T-blocks 70. The end 300 is attached to a motor (shown in phantom in FIGS. 1 and 2), such as through a coupling (e.g., “love-joy) or clutch mechanism as is known in the art. The screw is preferably mounted in each block by means of ball bearings, preferably of the flanged type. The pitch of the screw (and of the nut) may be varied as is known in the art. The motor is typically mounted to the stage with a bracket or by other means.

It is appreciated that the main plate may be easily manufactured, that the channels are easily formed therein by manufacturing methods known in the art (and that the channels are thus easily formed to be parallel with respect to each other), and that one “very long main plate” may be manufactured and then cut into many smaller main plates, reducing the cost and increasing the speed of production. The need for sidewalls, as well as front and rear walls, is eliminated because the plate is instead a single integral structure. Thus assembly time is significantly reduced; assembling the stage advantageously does not require mounting such walls to an additional structure, to each other, etc. Furthermore there are no such walls which might otherwise shift, e.g., under application of a heavy load in use, or if inadvertently stricken. It is very easy to keep the main plate clean, for there are relatively few “gaps” and crevices for dirt otherwise to accumulate. The regions of the main plate may be easily reached for cleaning. The material of each of the main plate and other components may be selected (and varied) as is known in the art. Aluminum is, of course, desirable as a material for many of the components (such as the main plate) because it is not susceptible to rust. The rails/guide blocks may include Teflon and other materials, as is known in the art. Stainless steel is another desirable material for the stage's components, also because of its resistance to rust,

Many advantages are inherent in the stage of the present invention. For example, the offset channels reduce the “effective height” of the rails, permitting the height of the stage to be lower. Simultaneously, the center channel accommodates the correspondingly lower screw, even one of a sufficient width to impart substantial rigidity thereto for certain applications. Because the offset channels reduce the “effective height” of the rails, custom-made short rails are not required but instead standard heights may be incorporated into the stage.

The deepest channel, namely the center channel, is advantageously in a position (of the main plate) that is under relatively little stress. Specifically, the region of the main plate proximate each rail is typically under significant stress, while the region of the main plate therebetween is under less stress. Thus the mere fact that the thickness of the main plate under the center channel is reduced does not significantly (if at all) weaken the stage and/or reduce its rigidity and load stability under torsion, compression, and tension.

The low profile stage of the present invention is particularly well-suited for multi-axis applications where multiple (two or more) stages are mounted to each other for forming various configurations, which configurations are known in the art. Because of the stability and rigidity of the stage, it may be mounted in various directions (e.g., upright, sideways, upside-down, etc.) while maintaining its desirable attributes.

While preferred embodiments of the stage have been disclosed for illustrative purposes, those who are skilled in the art will appreciate that various modifications, additions and substitutions are possible, without departing from the scope and spirit of the invention.

I claim:

1. A stage comprising:
(i) a main plate having top and bottom surfaces and having a center channel in said top surface, the center channel having front and back ends;
(ii) first and second bearing blocks attached to said main plate upon said top surface thereof and positioned proximate said respective front and rear ends of said center channel;
(iii) a screw secured between said first and second bearing blocks, wherein said screw is directly over said center channel and wherein said screw is rotatable about the longitudinal axis of said screw;
(iv) a carriage operatively engaged by said screw, wherein rotation of said screw causes displacement of the carriage along said longitudinal axis of the screw; and
(v) first and second linear rails attached to said main plate upon said top surface thereof, wherein both of said linear rails are parallel to said screw, wherein said first and second linear rails are equidistant from said screw on opposite sides thereof, and wherein said first and second linear rails operatively engage said carriage for permitting linear movement of the carriage therealong.
